(19) United States
(12) Patent Application Publication
(10) Pub. No.: US 2006/0140583 A1
(43) Pub. Date: Jun. 29, 2006

(54) Recording method of digital recording apparatus

(75) Inventors: Dong Hyeon Joh, Seoul (KR); Sang Kyu Cho, Seoul (KR)

Correspondence Address: JONATHAN Y. KANG ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/316,477

(22) Filed: Dec. 21, 2005

(30) Foreign Application Priority Data
Dec. 23, 2004 (KR) 2004-0111090

(51) Int. Cl. H04N 5/91

(52) U.S. Cl. 386/83

(57) ABSTRACT

A method for recording in a digital recording apparatus is disclosed, whereby storage suitable for recording a broadcasting program is determined in consideration of an expected data capacity of the broadcasting program. There is an advantage of solving the discomfort of manipulating an external key at every time when storage for recording the broadcasting program is to be established. There is another advantage of preventing unfinished recordings of the broadcasting program to a maximum.

This application claims the benefit of the Korean Patent Application Nos. 10-2004-0111090, filed on Dec. 23, 2004, which is hereby incorporated by reference herein in their entirety.

### BACKGROUND OF THE INVENTION

1. Field

The present document relates to a recording method of a digital recording apparatus for preventing an incomplete recording of a broadcasting program to a maximum.

2. Description of the Related Art

Recently, a digital recording apparatus storing a broadcasting data via digital method has been developed and used, unlike the Video Cassette Recorder (VCR) storing a broadcasting data on a magnetic tape via an analogue method.

Referring to FIG. 1, a digital recorder (100) records a broadcasting program on a storing apparatus such as a hard disc inherently mounted therein and connected to a digital TV set (200), and a representative digital recorder may be a Personal Video Recorder (PVR).

Meanwhile, recently, a digital recorder is structured in such a manner that a separate external auxiliary storing apparatus is mounted in addition to a storing apparatus inherently mounted therein, and the auxiliary storing apparatus thus connected stores the data.

There is a disadvantage in the conventional digital recorder equipped with a plurality of storing apparatus thus described in that a user should have to check a storing space remaining in each storing apparatus every time for establishing a storing apparatus for recording a broadcasting program, and establish an apparatus for recording the broadcasting program.

There is another disadvantage in that, if a storage capacity of the storing apparatus is not insufficient during an actual recording, the recording may be stopped in the midst thereof, or incomplete broadcasting program may be recorded, because the storage capacity is continuously changed due to certain reasons.

### SUMMARY OF THE INVENTION

The present invention is disclosed to solve the aforementioned disadvantages and it is an object of the present invention to provide a recording method of a digital recording apparatus for preventing an incomplete recording of a broadcasting program to a maximum.

In accordance with one object of the present invention, a recording method of a digital recording apparatus comprises: receiving from outside an immediate recording command of a broadcasting program; calculating an expected data capacity of the broadcasting program to be recorded in response to the received immediate recording command; determining a storage appropriate for recording the broadcasting program in response to the calculated expected data capacity; and recording the broadcasting program in the storage thus determined.

The calculating step of the expected data capacity of the broadcasting program comprises: receiving a recording execution time of the broadcasting program from outside; and calculating an expected data capacity of the broadcasting program to be recorded in response to the received recording execution time.

The step of calculating the expected data capacity of the broadcasting program comprises: reading Electronic Program Guide (EPG) information related to broadcasting time information of the broadcasting program; and calculating an expected data capacity of the broadcasting program to be recorded in response to the read EPG related to the broadcasting time information.

The step of determining a storage appropriate for recording the broadcasting program comprises: checking storage capacities of all the storages storable in response to the immediate recording command; detecting a storage medium (hereinafter referred to as storage) exceeding the expected data capacity calculated by the checked storage capacity; and determining a storage for differently recording the broadcasting program in response to whether the number of the detected storages is just one, plural or null.

If the number of detected storages is just one, it is determined that a relevant storage is the very storage for recording the broadcasting program.

If the number of detected storages is plural, a storage for recording the broadcasting program can be established in the following various methods.

A first step comprises: displaying information with regard to relevant storages; and determining as storage out of the displayed storages, the storage selected by a user for recording the broadcasting program.

A second step comprises: determining storage for recording the broadcasting program according to a pre-set priority, where the pre-set priority is established by a user command or a default command, and in this case, a top priority may be established at storage inside a digital recorder.

A third step comprises: determining storage of smallest storage capacity or largest storage capacity as storage for recording the broadcasting program if there are multiple detected storages.

A fourth step comprises: determining storage where the broadcasting program is recorded as storage for recording the broadcasting program if the detected storage is null, and deleting the previously recorded broadcasting program once the determination is made.

In accordance with another object of the present invention, a recording method of a digital recording apparatus comprises: receiving from outside a reservation recording information of a broadcasting program; calculating an expected data capacity of a broadcasting program to be recorded in response to the received reservation recording information; checking all the entire storable storage capacity before start of the recording in response to the received reservation recording information; determining storage appropriate for recording the broadcasting program in response to the calculated expected data capacity and all the checked storable storage capacity; and recording the broadcasting program in the determined storage.

The checking step comprises: setting a time for checking the storage capacity in response to the received reservation recording information; and checking the storage capacity of the storable storage before start of the recording in response to the set time.

The time for checking the storage capacity is calculated using a pre-set unit time for recording time and pre-process.

The step of calculating the expected data capacity of the broadcasting program comprises: receiving from outside a recording execution time of the broadcasting program; and calculating the expected data capacity the broadcasting program to be recorded in response to the received recording execution time.

The step of calculating the expected data capacity of the broadcasting program comprises: reading out Electronic Program Guide (EPG) information related to broadcasting time information of the broadcasting program; and calculating expected data capacity of the broadcasting program to be recorded in response to the EPG information related to the read-out broadcasting time information.

The determining step comprises: detecting storage having a checked storage capacity exceeding the expected data capacity; and differently determining storage for recording the broadcasting program depending on whether the detected storage is single, multiple or null.

The step of determining storage appropriate for recording the broadcasting program comprises: determining that a relevant storage is the very storage for recording the broadcasting program if the number of detected storages is just one.

The step of determining storage appropriate for recording the broadcasting program comprises: determining that a relevant storage is the very storage for recording the broadcasting program if the number of detected storages is just single.

If the number of detected storages is plural in the determining step, a storage for recording the broadcasting program can be established in the following various methods.

Firstly, the step comprises: displaying information with regard to the detected multiple storages; and determining as storage out of the displayed storages, the storage selected by a user for recording the broadcasting program.

Secondly, the step comprises: determining storage for recording the broadcasting program according to a pre-set priority, where the pre-set priority is established by a user command or a default command, and in this case, a top priority may be established at storage inside a digital recorder.

Thirdly, the determining step comprises: determining storage of smallest storage capacity or largest storage capacity as storage for recording the broadcasting program if there are multiple detected storages.

Fourthly, the determining step comprises: a case where the detected storage is null, and a case where storage where the broadcasting program is recorded is established as storage for recording the broadcasting program, and in this case further comprises: deleting the previously recorded broadcasting program once the establishment is made.

The expected data capacity is calculated by recording time information of the broadcasting program and quantity of data to be stored per unit time.

### BRIEF DESCRIPTION OF THE DRAWINGS.

For a better understanding of the invention, and to show how embodiments of the same may be carried into effect, reference will now be made, by way of example, to the accompanying diagrammatic drawings in which:

FIG. 1 is a schematic representation illustrating a digital recorder according to the prior art;

FIG. 2 is an exemplary representation illustrating a system to which the present invention is applied;

FIG. 3 is an exemplary representation illustrating a digital recorder according to the present invention;

FIGS. 4a and 4b are exemplary representations illustrating an User Interface (UI) screen used for the present invention.;

FIG. 5 is an exemplary representation illustrating a recording method according to the present invention;

FIG. 6 is a schematic representation illustrating a first embodiment of step S600 illustrated in FIG. 5;

FIG. 7 is a schematic representation illustrating a second embodiment of step S600 illustrated in FIG. 5; and

FIG. 8 is a schematic representation illustrating a third embodiment of step S600 illustrated in FIG. 5.

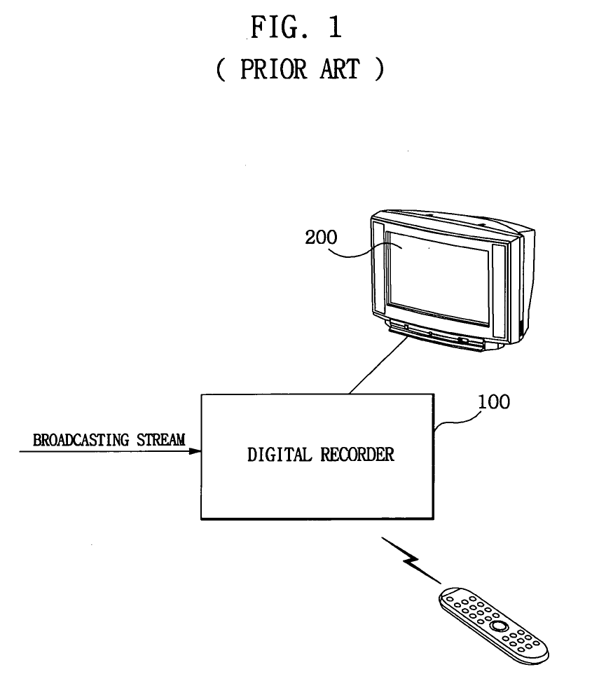

### DETAILED DESCRIPTION OF THE PREFERRED EMBODIMENTS

The detailed embodiments of the present invention are described below with reference to the drawings.

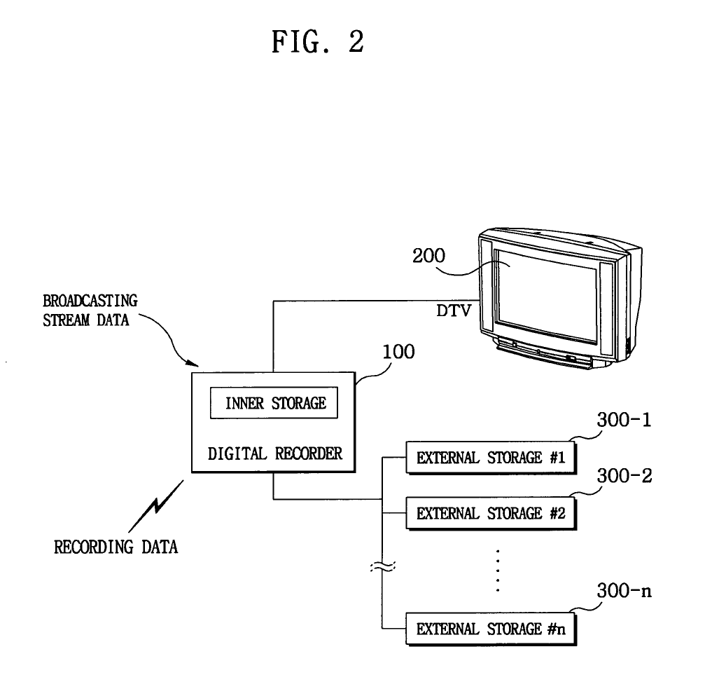

FIG. 2 is a schematic representation illustrating an example of a system applied with the present invention that includes a digital TV receiver (DTV 200), a digital recorder (100) determining, immediately or just before the start of recording, a storage suitable for recording the broadcasting program in response to an immediate recording command or a reservation recording command inputted from outside, out of inner storages or external storages, and the inner storages and the external storages (300-1, 300-2, . . . , 300-n ) selectively recording the broadcasting program in response to the determination of the digital recorder (100)

The digital recorder (100), before determining a storage suitable for recording the broadcasting program, checks all the immediately storable storages if an immediate recording command against a certain broadcasting program is inputted from outside. Furthermore, if there is inputted a reservation recording command from outside, the digital recorder (100) checks all the storable storages just before the start of the recording.

The storages to be checked in the present invention include all the inner storages such as hard disc and the like and the external storages (300-1, 300-2, . . . , 300-n ) connected via external data input/output ports. The information to be checked includes information on, for example, codes for distinguishing respective storages, entire storage capacity of each storage and current time storage capacity.

If the information to be checked can be obtained from a system manager managing the conventional File Allocation Table (FAT) information if the relevant storage is an inner storage such as hard disc or the like. If the relevant storage is an external storage, a request signal for device information is transmitted and the information to be checked can be obtained from a response therefrom.

The above checking is conducted periodically, and in case of reservation recording, a separate storing part is provided before the start of the recording for a rapid access, and the checked information relative to respective storages is set therein, and if the determination regarding storage for recording the broadcasting program is completed, the information is reset.

The digital recorder (100) uses, as information necessary for determining a device suitable for storing the broadcasting program to be recorded, the above-checked information and the expected data capacity of the broadcasting program to be recorded.

The expected data capacity of the broadcasting program to be recorded is calculated by using bit rate information obtained by writing in a First In First Out (FIFO) buffer the data embedded in a transport packet in which received MPEG-2 transmission data is decoded and reconstructed, and recording execution time information of relevant broadcasting program.

The recording execution time is obtained from time information inputted from outside in relation to the recording execution time, or EPG information related to the broadcasting time information of the broadcasting program.

The digital recorder (100) uses the afore-mentioned storage capacity of respective storages and the expected storage capacity of the broadcasting program to be recorded to determine a recording storage, detailed determination method thereto will be described with reference to related drawings.

The external storage may be a memory stick, a CD/DVD-R, a CD/DVD-RW, an externally equipped hard disc, a memory card. The digital recorder (100) can selectively record the broadcasting program on either the external storages (300-1, 300-2, . . . , 300-n ), or the inner storages according to the afore-mentioned determination.

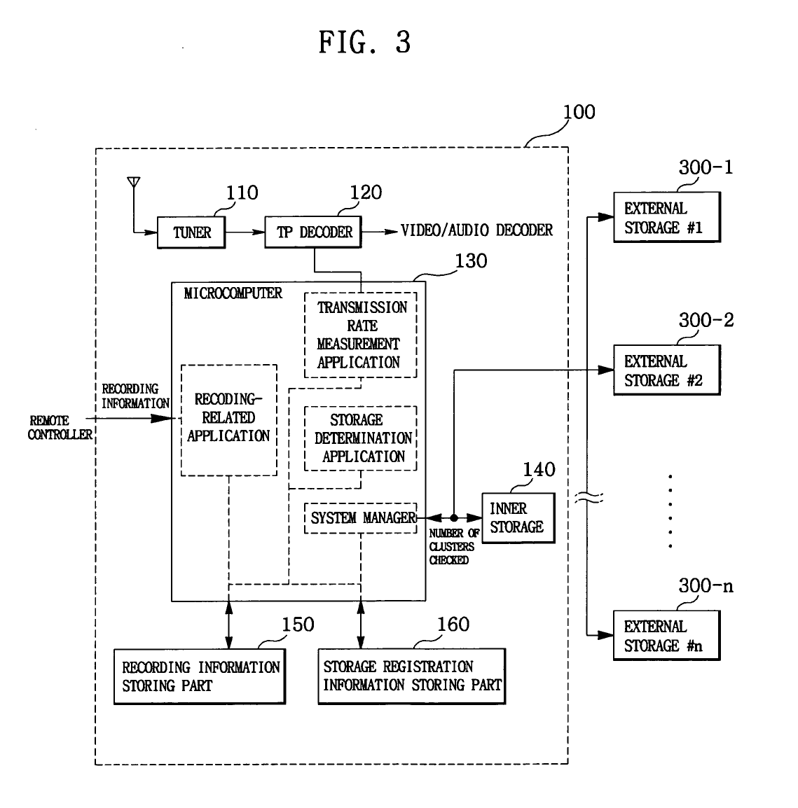

A digital recorder illustrated in FIG. 3 is an exemplary digital recorder according to the present invention, and is largely comprised of a tuner (100), a TP (Transport Packet) decoder (120), a microcomputer (130), an inner storage (140), recording information storing part (150) and a storage registration information storing part (160).

Particularly, the microcomputer (130) is comprised of a transmission rate measurement application interfacing with the TP decoder (120), a recording-related application interfacing a key input part, a system manager checking file system information of each device interfacing with all the storable devices, for example, storage capacity, an immediate recording command inputted from outside, or storage determining application for determining storage for recording a predetermined broadcasting program.

The transmission rate measurement application includes a task for measuring a digital transmission rate of broadcasting stream by interfacing the TP decoder (120). The expected data capacity of the broadcasting program to be recorded is calculated per the following Equation 1 based on a digital transmission rate measured by using the task and recording execution time.
Expected data capacity of broadcasting program to be recorded (Mbyte)=recording execution time(seconds)×digital transmission rate per second, [EQUATION 1]

where, the digital transmission rate per second can be obtained by a write prime temporarily stored in a buffer of the TP decoder (120), a next write prime for a packet (where a lead frame is set) to be outputted from the buffer, or bit rate per second up to a time for a packet (where a lead frame is set) to be outputted from the buffer.

Furthermore, the digital transmission rate per second can be obtained in a shape of fixed bit rate embedded in a video header of MPEG video stream, and in case of ATSC, 19M bit/second may be obtained. In this case, a broadcasting program of 60 minutes needs an approximate capacity of 64800 Mbit.

The recording execution time may be obtained from time information inputted from outside in relation to the recording execution time, or EPG information with regard to televising time information of the broadcasting program, and the EPG information in relation to the televising time information is supported by a conventional data broadcasting.

The recording related application is equipped for reservation recording, and receives the recording time information obtained by interfacing the key input part and information related to recording of channel and name of the broadcasting program and registers same in the recording information storing part (150). The recording related application includes an Application Programming Interface (API) function related to a user enabling to watch from outside the data related to recording in cooperation with EPG module.

The system manager detects the size of voltage of an output port variable to access or non-access to an external storage relative to an external input/output port and checks its access state. Then, the system manager transmits a request signal with regard to device information and receives information related to storage capacity or discriminating code unique to the external storage received as a response thereto.

Furthermore, the system manager checks file system information of, for example, the external storage and the inner storage, particularly the storage capacity.

The check is periodically conducted, and in case of reservation recording, a separate storing part is provided before the start of the recording for a rapid access, and the checked information relative to respective storages is set therein, and if the determination regarding storage for recording the broadcasting program is completed, the information is reset. Particularly, the checking of the storage capacity of the inner storage is executed in the following manner.

The number of unit storage regions activated by storage or non-storage of information is counted, and the number thereof and set data quantity storable in one unit storage region are operated, and the operated storage capacity is deducted from an entire storage capacity to obtain information on a current storage capacity.

Or, the number of inactivated unit storage regions is counted, and the number thereof and set data quantity storable in one unit storage region are operated to obtain information on a current storage capacity.

Each information is continuously updated and is used as information on accurate storage capacity of the storages storable just before the start of the recording, and the unit storage region may be a conventional cluster if the storage is an internally-equipped hard disc or an externally-equipped hard disc.

The storage determining application determines storage for recording the broadcasting program and may execute the determination in the following fashion.

First, a user personally executes, and an UI screen containing information on each storage and storage capacity is provided. Furthermore, externally set information is received via the UI screen thus provided, and storage for recording the broadcasting program is determined according to the set information. The storage thus determined is provided with separate identifying information in the form of an identifier or a descriptor.

Second, the checked storage capacity and the expected data capacity of the to-be-recorded broadcasting program are compared to detect a storage exceeding the expected data capacity. Successively, a storage for recording the broadcasting program is differently set according to the detected device being one, multiple or null. For example, if the detected storage is single, a relevant storage is determined as the storage for recording the broadcasting program. Then, if the detected storage is multiple, determination of storage for recording the broadcasting program is variously implemented by steps given below.

A first step is based on a user's selection of displaying information with regard to relevant storages in conformity with the recording time, for example, the device name of each storage and storage capacity, and determining as storage out of the displayed storages, the storage selected by the user for recording the broadcasting program.

A second step is based on priority, which is determining storage for recording the broadcasting program according to a pre-set priority, regardless of each storage capacity being small or large and as long as storage capacity of each storage exceeding the expected data capacity of the broadcasting program to be recorded, where the priority is pre-set by a user command or a default command, and in this case, a top priority may be established at storage inside a digital recorder for stable data storage.

A third step is based on a difference between the storage capacity and the expected storage capacity of broadcasting program to be recorded, where a difference between the storage capacity of each storage and the expected storage capacity of the broadcasting program to be recorded is obtained, and a maximum difference or a minimum difference may be set up as storage for recording the broadcasting program. The minimum difference being determined as storage for recording the broadcasting program can be the following case.

For example, if the storage capacity of a certain storage is 10 minutes if converted into time, storage capacity of another storage is 60 minutes, an expected data capacity of a to-be-currently recorded broadcasting program is 10 minutes, and an expected data capacity of successively to-be-recorded broadcasting program is 60 minutes, the current to-be-recorded broadcasting program is preferred to be determined by storing of the first storage.

A fourth step comprises: determining storage where the broadcasting program is recorded as storage for recording the broadcasting program if the detected storage is null; and deleting part or all of the previously recorded broadcasting program from the relevant storage once the establishment is executed, where the deleting method is a known art which can be applied hereto.

Meanwhile, particularly, in case of reservation recording, it is preferred that a time for checking the storage capacity is pre-set, all the storage capacity of storable devices is checked according to the pre-set time, and a storage for recording the broadcasting program is set in consideration of the checked result.

A flag value may be set for a code indicating a descriptor describing the relevant storage or the name of the relevant storage in order to identify it from other storages thus set, and the storage for recording the relevant broadcasting program can be identified by referring to the flag value during the actual recording procedure.

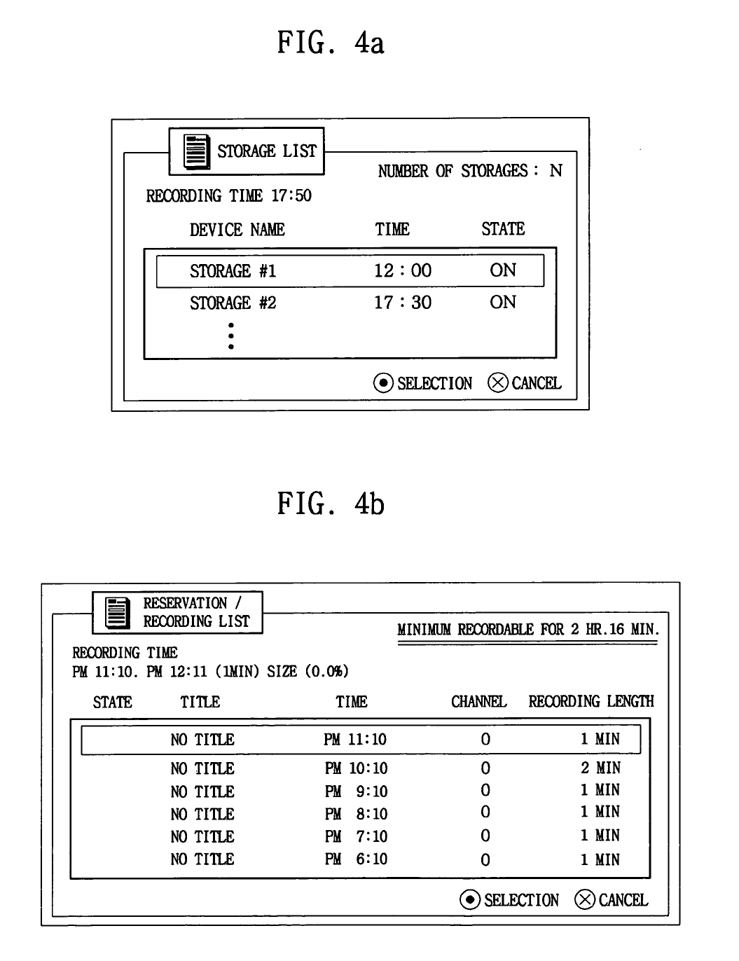

A display screen illustrated in FIG. 4a is one of the User Interface (UI) screens provided for the present invention, where cursor movement and question processing on the UI screen are executed by short-cut key or function key, and field movement complies with the conventional way or a separately provided essential input and a selective input standard. The storable storages are searched with respect to outside-inputted immediate recording command, or reservation recording command, and information thereon, for example, device name of each storage, accessed time information and state information of respective storages at present time is provided.

A display screen illustrated in FIG. 4b is one of the User Interface (UI) screens provided for the present invention. The information via FIG. 4b includes storage capacity of a storage selected via FIG. 4a at the present time, a time for recording (it is denoted in the drawing as ‘recording length’). Furthermore, along with the information thus explained, the expected data capacity of broadcasting program to be recorded may be included. The recording time corresponds to a value converted in terms of time of an expected data capacity of the to-be-recorded broadcasting program.

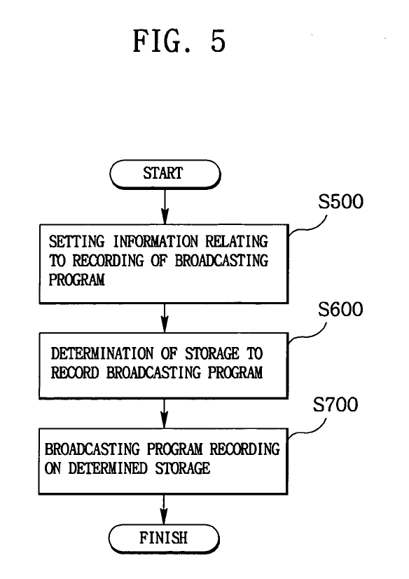

FIG. 5 is an exemplary representation illustrating a recording method according to the present invention, particularly a recording method applied to reservation recording.

As illustrated in FIG. 5, the recording method according to the exemplary embodiment of the present invention comprises; setting information with regard to recording of a predetermined broadcasting program including the recording time (S500); determining a storage for recording the broadcasting program before the start of the recording (S600); and recording the broadcasting program on the storage determined via S600.

The step of S500 includes comprises: information with regard to recording such as recording time, name of the broadcasting program and channel information and the like; generating information corresponding thereto; and setting it on a pre-set table.

The step of S600 comprises determination of storage for recording the recorded information set via S500, for example, the broadcasting program according to the recording time. In this case, as the present time within the system is adjacent to the recording time, a storable storage is searched, and storage for recording the broadcasting program is determined out of the searched storages.

The step of S700 comprises the actual recording of the broadcasting program on the storage determined via S600, detailed description of which is omitted as it is well known art.

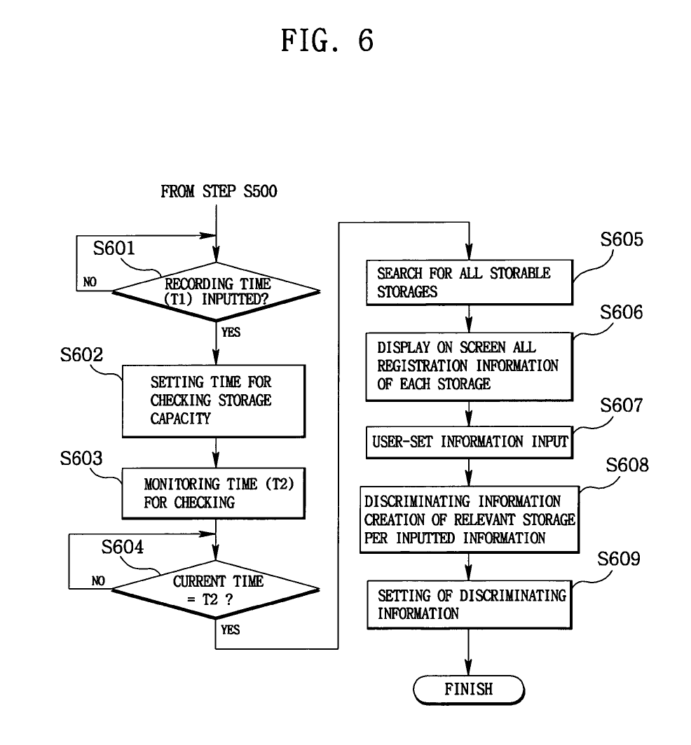

FIG. 6 is a schematic representation illustrating a first embodiment of step S600 illustrated in FIG. 5.

The step of S600 describes a structure of manually determining storage for recording the broadcasting program, and more particularly includes steps from S601 through S609.

First of all, if it is discriminated that a recording time (T1) is received according to S601 while monitoring outside inputted information at S602, a time for checking the storage capacity is set according to the inputted recording time, for example, a time (T2) for checking the storage capacity is set as the recording time (T1). Furthermore, the setting may be established by using a unit time pre-set for a pre-process. In other words, a result of subtracting the pre-set unit time from the recording time (T-1) may be established. The time (T2) for checking the storage capacity thus established is periodically stored in a storing part capable of outputting the information, and if recording of the relevant broadcasting program is completed, the time is reset.

At S605, the time for checking the storage capacity is monitored (S603), and a comparison (S604) is made between the present time outputted from a system timer in the digital recorder and a time for checking the storage capacity set at S602. As a result of the comparison, if two times are identical, all the storable devices are searched at the very point, from which file system information of each device, particularly information on the storage capacity is obtained.

For example, the number of unit storage regions activated at each device according to whether information has been stored is counted, and the number and the established data quantity storable in the unit storage region are operated, and information on the current storage capacity is obtained by subtracting the operated storage capacity from the entire storage capacity. Furthermore, the number of inactivated unit storage regions is counted, and the number and the established data quantity storable in the unit storage region are operated to obtain information on the current storage capacity. The respective information is continuously updated and is used as information on accurate storage capacity of storable storages in conformity with the recording time, and the unit storage region can be a conventional cluster if the storage is an internally-equipped hard disc or an externally-equipped hard disc.

The step of S609 is for establishing storage for recording the broadcasting program, where each storage searched from S605 and information on the storage capacity of the storage are displayed on a screen (S606). Furthermore, a storage selected by a user based on the information displayed at S606 is received (S607). Then, information is created (S608) on discrimination of relevant storage according to the information received from S607, and relevant identifier is set (S609). The identifier may be a flag value or a descriptor of a message form, and once the recording is completed, the identifier is reset.

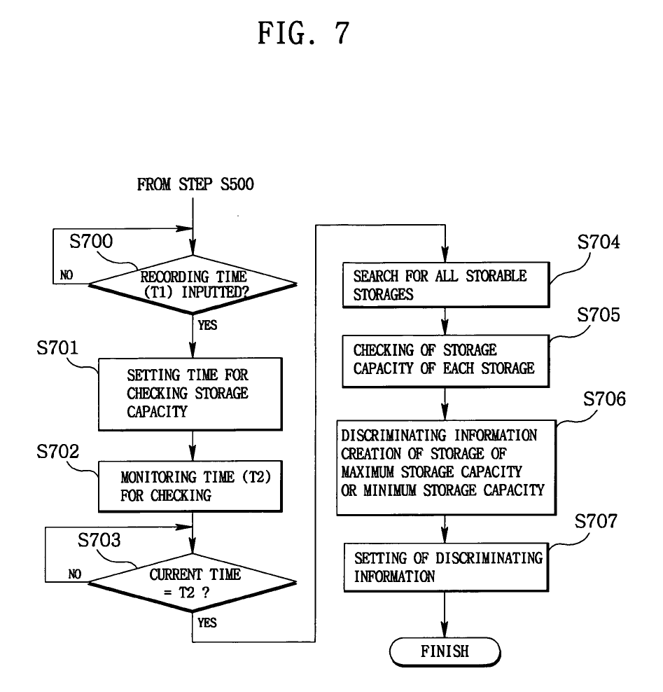

FIG. 7 is a schematic representation illustrating a second embodiment of step S600 illustrated in FIG. 5.

The step S600 illustrated in FIG. 7 shows an automatic establishing of storage for recording the broadcasting program. Particularly, the step shows an establishment of the maximum storage capacity as storage for recording the broadcasting program just before the start of the recording. To be more specific, the step includes steps from S700 through S707.

First of all, in the step of S701, external input information is monitored and if it is discriminated that the recording time (T1) is inputted according to step S700, the time (T2) for checking the storage capacity is set in conformity with the inputted recording time.

For example, the storage capacity may be established as the recording time (T1) for checking the storage capacity, or the establishment can be made using the pre-set unit time for pre-process. In other words, the time (T2) for checking the storage capacity thus established is periodically stored in a storing part capable of outputting the information, and if recording of the relevant broadcasting program is completed, the time is reset.

At S704, the time for checking the storage capacity is monitored (S702), and a comparison (S703) is made between the present time outputted from a system timer in the digital recorder and a time for checking the storage capacity set at S701. As a result of the comparison, if two times are identical, all the storable devices are searched at the very point, from which file system information of each device, particularly information on the storage capacity is checked (S705).

Lastly, according to the checked result from S705, the maximum storage capacity is established as storage for recording the broadcasting program. For example, as a result of S705, information capable of discriminating storage having the maximum storage capacity or minimum storage capacity is created, and setting is made in such a manner that the device name of the relevant storage is provided with a flag value (S707). A descriptor with regard to the relevant device is created and a separate table is set. Once the recording is completed, the information may be reset.

Particularly, a case of determining storage for recording the broadcasting the program by a difference between the storage capacity of the device and the expected data capacity of the to-be-recorded broadcasting program can be given as below.

For example, if the storage capacity of a certain storage is 10 minutes if converted into time, storage capacity of another storage is 60 minutes, an expected storage capacity of a to-be-currently recorded broadcasting program is 10 minutes, and an expected data capacity of successively to-be-recorded broadcasting program is 60 minutes, the current to-be-recorded broadcasting program is preferred to be determined by storing of the first storage.

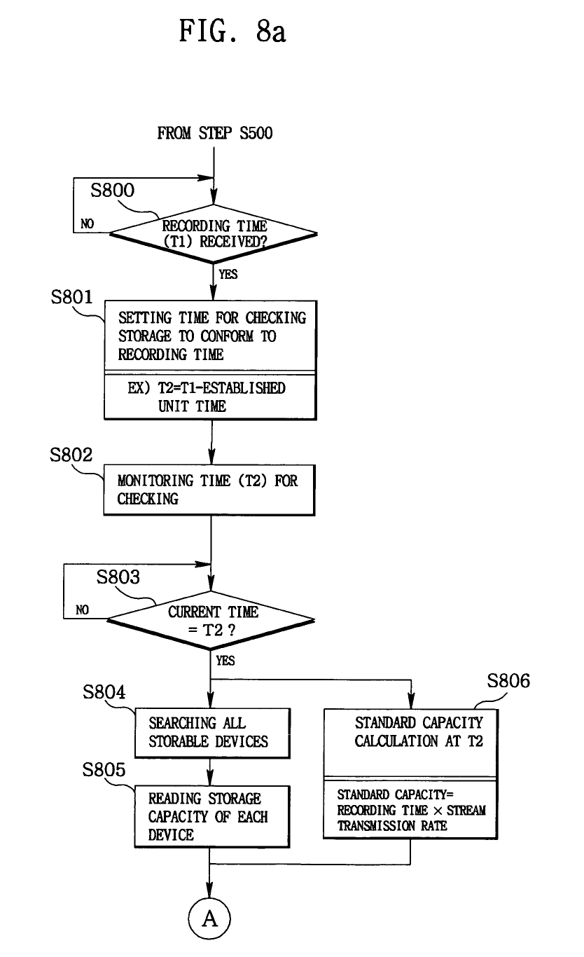

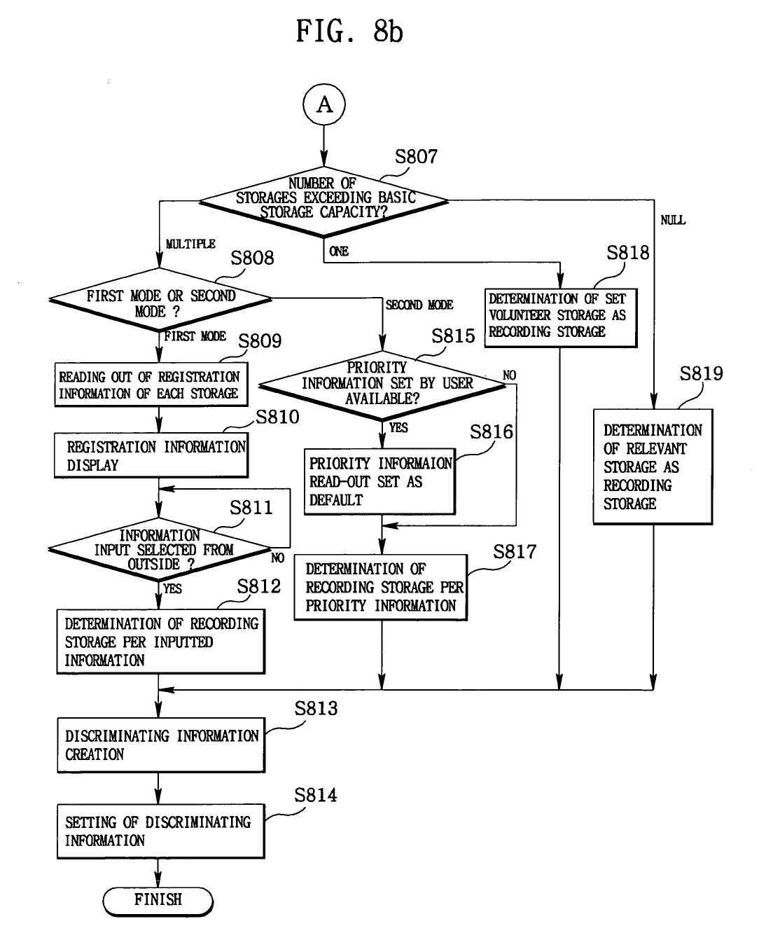

FIG. 8 is a schematic representation illustrating a third embodiment of step S600 illustrated in FIG. 5.

The step of S600 in FIG. 8 shows an establishing process of a device for storing the to-be-recorded broadcasting program in consideration of the data size of the to-be-recorded broadcasting program. To be more specific, the step comprises S800 through S814.

First of all, if it is discriminated that the recording time (T1) is inputted according to S800, a time (T2) for checking the storage capacity is set just before the start of the recording (S801). For example, the time (T2) for checking the storage capacity is established as the recording time (T1). Furthermore, the establishment can be made using the pre-set unit time for pre-process. In other words, the time (T2) for checking the storage capacity thus established is periodically stored in a storing part capable of outputting the information, and if recording of the relevant broadcasting program is completed, the time is reset.

At S804, the time for checking the storage capacity is monitored (S603), and a comparison (S604) is made between the present time outputted from a system timer in the digital recorder and a time for checking the storage capacity set at S602. As a result of the comparison, if two times are identical, all the storable devices are searched at the very point, from which file system information of each device, particularly information on the storage capacity is read out (S805).

Furthermore, apart from the step of S804, a standard capacity is calculated in conformity with the time 9T2) for checking the storage capacity (S806).

The standard capacity is the expected data capacity of the broadcasting program calculated to suit the recording time, and may be calculated by using the recording time information of the broadcasting program and the data quantity stored per unit time.

For example, the expected data capacity of the broadcasting program is anticipated per the said Equation 1 based on the digital transmission rate and the recording execution time.
Expected data capacity of broadcasting program to be recorded (Mbyte)=recording execution time(seconds)×digital transmission rate per second, 8 EQUATION 1]

where, the digital transmission rate per second can be obtained by a write prime temporarily stored in a buffer of the TP decoder (120), a next write prime for a packet (where a lead frame is set) to be outputted from the buffer, or bit rate per second up to a time for a packet (where a lead frame is set) to be outputted from the buffer.

Next, the checked storage capacity and the standard capacity are compared (S807), and a storage having a storage capacity exceeding the standard capacity is detected. Successively, a storage for recording the broadcasting program is differently set according to the detected device being one, multiple or null. To begin with, if the detected storage is single, i.e., if the storage having a storage capacity exceeding the standard capacity is single, the storage is established as a storage for recording the broadcasting program.

If the detected storage is multiple, the storage for recording the broadcasting program may be differently established as under.

First step is based on a user's selection. Information with regard to relevant storages in conformity with the recording time is read out (S809). For example, the device name of each storage and storage capacity are displayed (S810), and the storage selected by the user for recording the broadcasting program is established as the storage for recording the broadcasting program according to step of S811 out of the displayed storages (S812).

Then, information capable of discriminating the relevant storage according to the information established at step of S812 is created (S813), and a relevant identifier is set (S814). The identifier may be a flag value or a descriptor of a message form, and once the recording is completed, the identifier is reset. The information with regard to the storages is supported by a system manager managing the conventional FAT (File Allocation Table) information.

A second step is based on priority. The storage for recording the broadcasting program is forcibly established according to the pre-set priority, where the priority may be pre-set by a user command or a default command, and in this case, a top priority may be established at storage inside a digital recorder for stable data storage.

At this time, check is first made on whether there is priority information established by the user (S815), and if there is no information on the priority established by the user, a priority established as default is read out, and the recording storage is determined per the priority read out at S816 (S817).

Meanwhile, the storage is determined where the broadcasting program is recorded as storage for recording the broadcasting program if the detected storage is null (S818). Part or all the previously recorded broadcasting programs is deleted from the relevant storage once the determination is made, where the deleting method is a known art and detailed description thereto is omitted.

The present invention has been described above in varied detail by reference to particular embodiments and figures. However, these specifics should not be considered as limitations on the scope of the invention, but merely as illustrations of some of the presently preferred exemplary embodiments. It is to be further understood that other modifications or substitutions may be made to one skilled in the art without departing from the broad scope of the invention. The modifications or substitutions should not be understood individually from the scope of the technical ideas or aspects of the present invention.

What is claimed is:

1. A recording method of a digital recording apparatus comprising:
receiving from outside an immediate recording command of a broadcasting program;
calculating an expected data capacity of the broadcasting program to be recorded in response to the received immediate recording command; determining a storage appropriate for recording the broadcasting program in response to the calculated expected data capacity; and
recording the broadcasting program in the storage thus determined.

2. The method as defined in claim 1, wherein the calculating step of the expected data capacity of the broadcasting program comprises:
receiving a recording execution time of the broadcasting program from outside; and
calculating an expected data capacity of the broadcasting program to be recorded in response to the received recording execution time.

3. The method as defined in claim 1, wherein the step of calculating the expected data capacity of the broadcasting program comprises;
reading Electronic Program Guide (EPG) information related to broadcasting time information of the broadcasting program; and
calculating an expected data capacity of the broadcasting program to be recorded in response to the read EPG related to the broadcasting time information.

4. The method as defined in claim 1, wherein the step of determining a storage appropriate for recording the broadcasting program comprises:
checking storage capacities of all the storages storable in response to the immediate recording command;
detecting a storage medium (hereinafter referred to as storage) exceeding the expected data capacity calculated by the checked storage capacity; and
determining a storage for differently recording the broadcasting program in response to whether the number of the detected storages is just one, plural or null.

5. The method as defined in claim 4, wherein, if the number of detected storages is just one, it is determined that a relevant storage is the very storage for recording the broadcasting program.

6. The method as defined in claim 4 comprising:
displaying information with regard to relevant storages; and determining as storage out of the displayed storages, the storage selected by a user for recording the broadcasting program, if the number of detected storages is plural.

7. The method as defined in claim 4 comprising:
determining storage for recording the broadcasting program according to a pre-set priority, if there are multiple detected storages.

8. The method as defined in claim 4 comprising:
determining storage of smallest storage capacity as the storage for recording the broadcasting program, if there are multiple detected storages.

9. The method as defined in claim 4 comprising:
determining storage of largest storage capacity as storage for recording the broadcasting program if there are multiple detected storages.

10. The method as defined in claim 4 comprising:
determining storage where the broadcasting program is recorded as storage for recording the broadcasting program if the detected storage is null.

11. The method as defined in claim 4 further comprising:
deleting the previously recorded broadcasting program once the determination is made.

12. A recording method of a digital recording apparatus comprising:
receiving from outside a reservation recording information of a broadcasting program;
calculating an expected data capacity of a broadcasting program to be recorded in response to the received reservation recording information;
checking all the entire storable storage capacity before start of the recording in response to the received reservation recording information;
determining storage appropriate for recording the broadcasting program in response to the calculated expected data capacity and all the checked storable storage capacity; and
recording the broadcasting program in the determined storage.

13. The method as defined in claim 12, wherein the step of calculating the expected data capacity comprises:
receiving from outside a recording execution time of the broadcasting program; and
calculating the expected data capacity of the broadcasting program to be recorded in response to the recording execution time.

14. The method as defined in claim 12, wherein the step of calculating the expected data capacity comprises:
reading out time information of the broadcasting program from within the Electronic Program Guide (EPG) information; and
calculating the expected data capacity of the broadcasting program to be recorded in response to the read-out time information.

15. The method as defined in claim 12, wherein the checking step of all the storage capacity comprises:
setting a time for checking the storage capacity in response to the received reservation recording information; and
checking the storage capacity of the storable storage before start of the recording in response to the set time.

16. The method as defined in claim 12, wherein the time for checking the storage capacity is calculated using a pre-set unit time for recording time and pre-process.

17. The method as defined in claim 12, wherein the step of determining storage appropriate for recording the broadcasting program comprises:
detecting storage having a checked storage capacity exceeding the expected data capacity; and
differently determining storage for recording the broadcasting program depending on whether the detected storage is single, multiple or null.

18. The method as defined in claim 12, wherein the step of determining storage appropriate for recording the broadcasting program comprises:
determining that a relevant storage is the very storage for recording the broadcasting program if the number of detected storages is just single.

19. The method as defined in claim 12, wherein the step of determining storage appropriate for recording the broadcasting program comprises:
displaying information with regard to the detected storages if the number of detected storages is multiple; and
determining as storage out of the displayed storages, the storage selected by a user for recording the broadcasting program.

20. The method as defined in claim 12, wherein the step of determining storage appropriate for recording the broadcasting program comprises:
determining storage for recording the broadcasting program according to a pre-set priority if the detected storage is multiple.

21. The method as defined in claim 20, wherein the pre-set priority is established by a user command.

22. The method as defined in claim 20, wherein the pre-set priority is a default command.

23. The method as defined in claim 20, wherein a top priority is established at storage inside a digital recorder.

24. The method as defined in claim 12, wherein the step of determining storage appropriate for recording the broadcasting program comprises:
determining storage of smallest storage capacity as the storage for recording the broadcasting program if the detected storages are multiple.

25. The method as defined in claim 12, wherein the step of determining storage appropriate for recording the broadcasting program comprises:
determining storage of largest storage capacity as the storage for recording the broadcasting program if the detected storages are multiple.

26. The method as defined in claim 12, wherein the step of determining storage appropriate for recording the broadcasting program comprises:
determining storage where the broadcasting program is already recorded as the storage for recording the broadcasting if the detected storage is null.

27. The method as defined in claim 26, wherein the step of determining storage appropriate for recording the broadcasting program further comprises:
deleting the previously recorded broadcasting program.

28. The method as defined in claim 1, wherein the expected data capacity is calculated by recording time information of the broadcasting program and quantity of data to be stored per unit time.

29. The method as defined in claim 12, wherein the expected data capacity is calculated by recording time information of the broadcasting program and quantity of data to be stored per unit time.
